(19) United States
(12) Patent Application Publication
(10) Pub. No.: US 2014/0196435 A1
(43) Pub. Date: Jul. 17, 2014

(54) Space Impulse Drive

(71) Applicant: Eugenio Sanchez-Gil, Madrid (ES)

(72) Inventor: Eugenio Sanchez-Gil, Madrid (ES)

(21) Appl. No.: 13/740,209

(22) Filed: Jan. 13, 2013

(51) Int. Cl. F02K 9/00

(52) U.S. Cl. CPC F02K 9/00
USPC 60/200.1

(57) ABSTRACT

Invention discloses an Impulse Drive useful to propel all types of flying, water or land vehicles or devices, without need of the lift the fluid air or water could provide.

Propulsion is accomplished by the resultant force of a rotating impulse drive submerged in a fluid that is adjacent to a pressurized gas chamber, separated by a flexible membrane. Multiple impulse drives can be coupled to eliminate rotational movement components, resulting in unidirectional impulse force.

Properly installed in a vehicle, it displaces it in the desired direction. This displacement can be performed equally in vacuum. It can be installed inside or outside the vehicle.

### SUMMARY OF THE INVENTION

Invention consists of an Impulse Drive useful to propel all types of flying vehicles, water or land vehicles, without need of the lift the fluid air or water could provide.

Properly installed in a vehicle, it displaces it in the desired direction. This displacement can be performed equally in vacuum. It can be installed inside or outside the vehicle. Since the mechanism is fully enclosed, it can be silent and not cause discomfort or a safety hazard. It needs a source of energy or power for operation.

### BACKGROUND AND RELATED ART OF THE INVENTION

No prior art related in any way to this invention has been identified.

### FIELD OF THE INVENTION

The invention pertains to the field of fluid-surface reaction impulse drive, within the subfield of Impellers driven by a fluid motor.

### BRIEF DESCRIPTION OF THE DRAWING

FIG. 1—SPACE DRIVE. Descriptive view of the internal distribution

FIG. 2—SPACE DRIVE. Perspective view overlooking the Interior.

FIG. 3—SPACE DRIVE. Elevation view.

FIG. 4—WHEEL DRIVE. Perspective view. Short axis.

FIG. 5—SPACE DRIVE. Alternative with 8 blades.

FIG. 6—SPACE DRIVE. Alternative with 6 curved blades.

FIG. 7—SPACE DRIVE. Alternative with 4 blades.

FIG. 8—WHEEL DRIVE. Alternative with long axis.

FIG. 9—SPACE DRIVE. Option descriptive of construction.

### DETAILED DESCRIPTION OF THE INVENTION

Description of Space Impulse Drive—

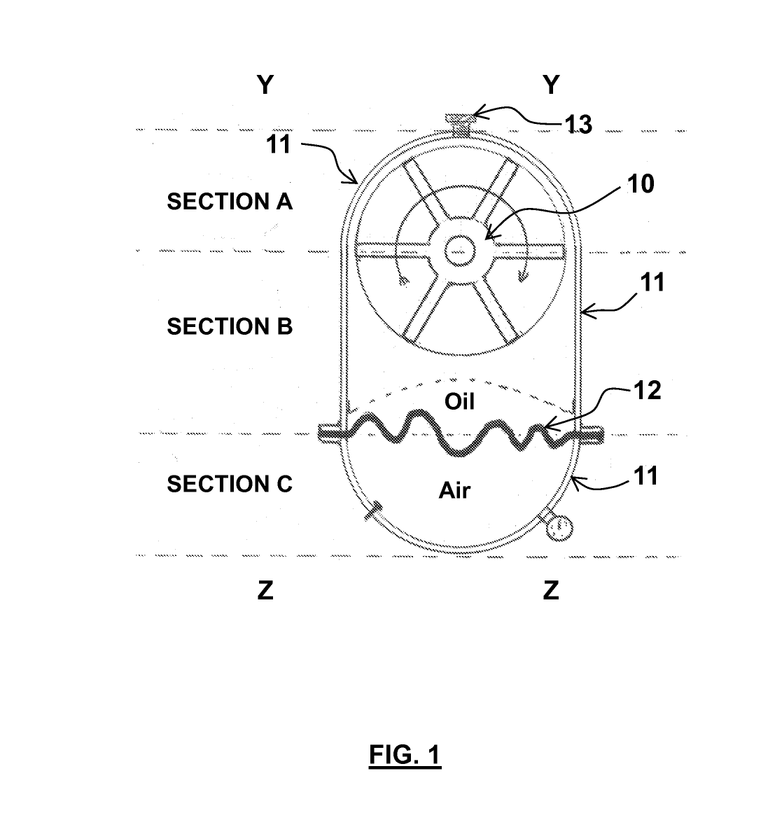

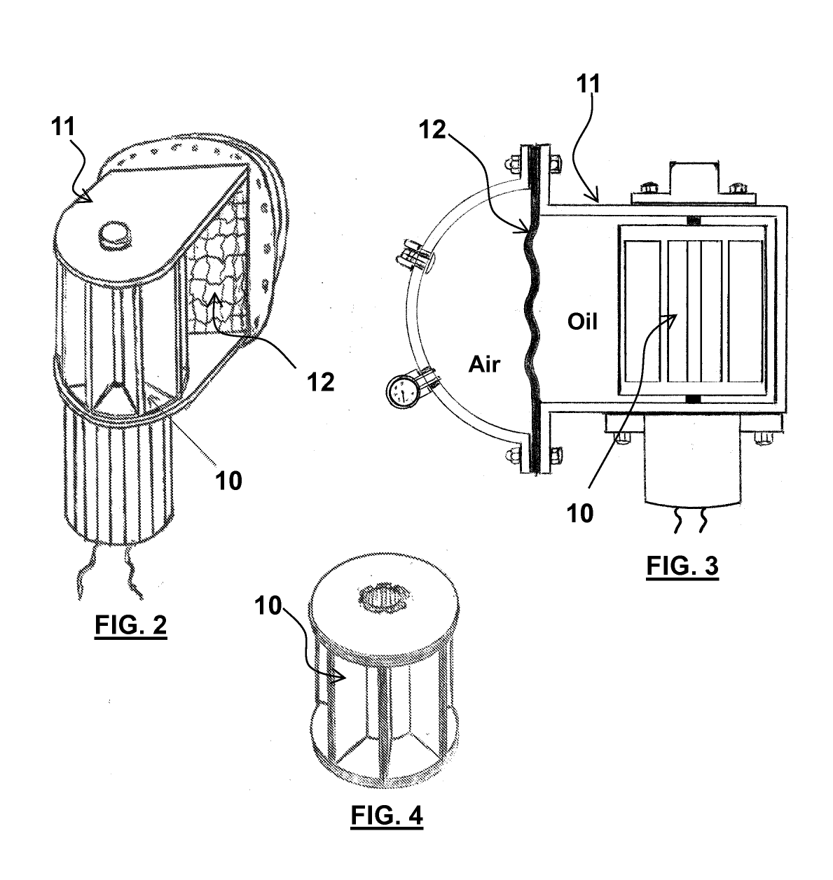

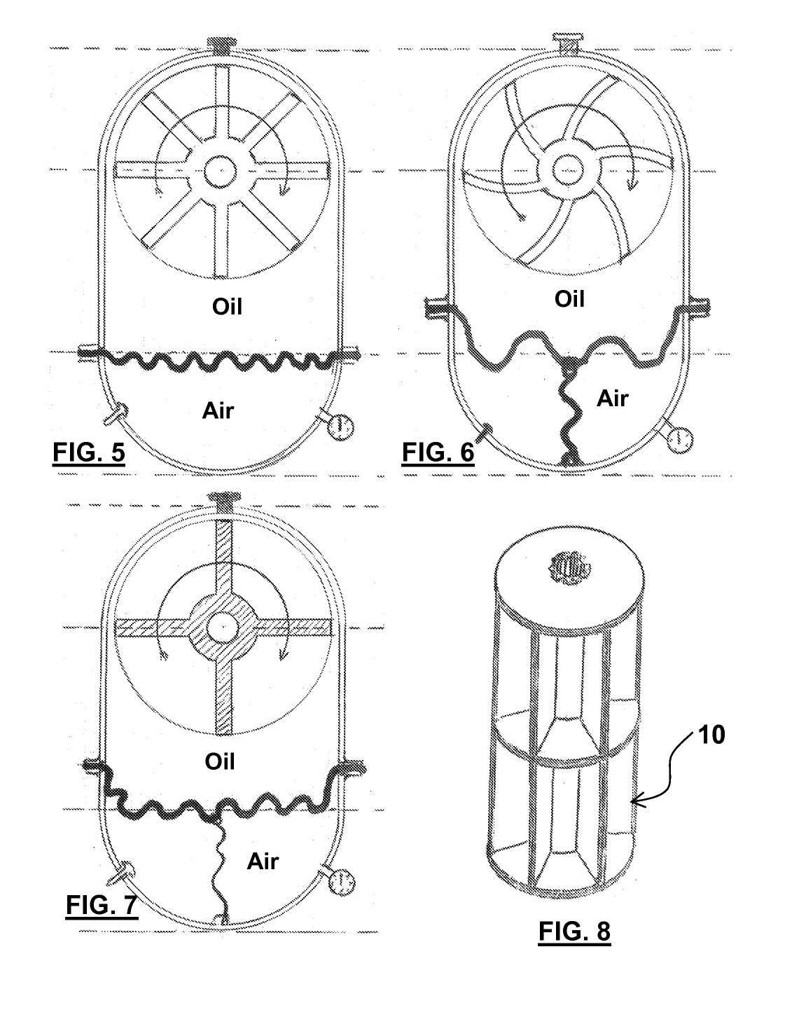

The space drive (FIGS. 1, 2, and 3) can be constituted by a closed container (11) in the form of quadrangular prism with two irregular bases. One base is adapted to the curvature the impulse wheel installed inside of the container, and the other one with flexible design. It is divided into two parts separated by a flexible membrane (12). One of the parts is filled with pressurized air and the other with oil. The air pressure is transmitted through the flexible membrane (12) to the oil that fills the other part of the container (11). Submerged in the oil, the impulse wheel is connected to a sealed electric motor.

Description of the parts—

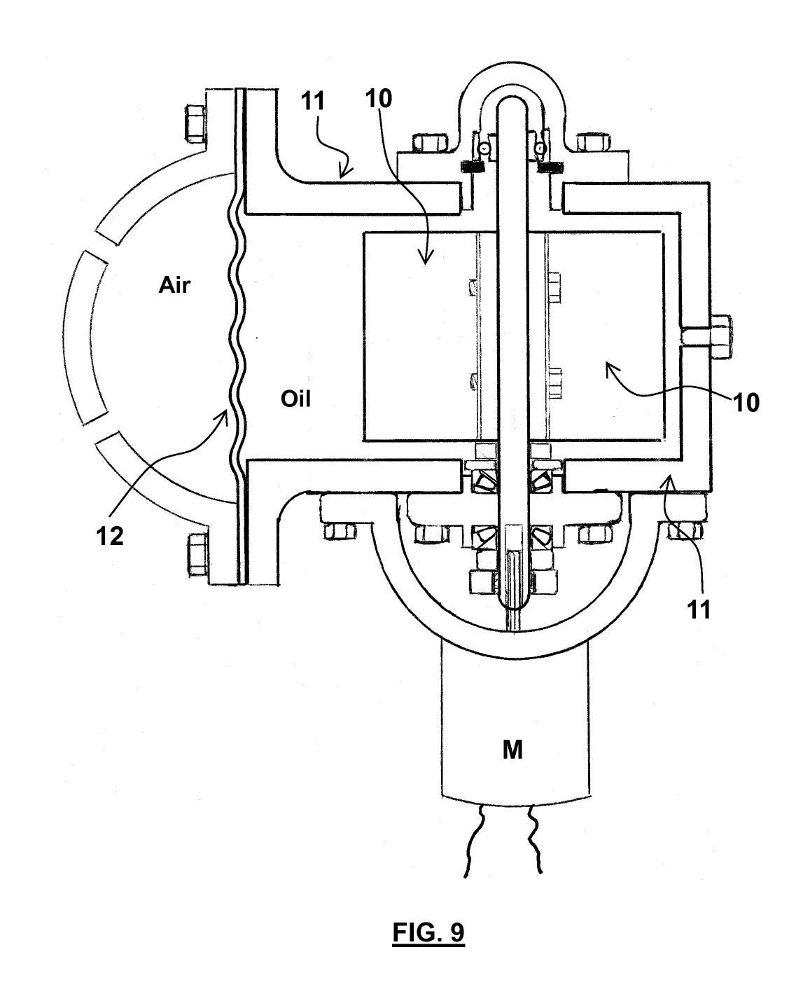

The impulse wheel (FIGS. 4 and 8), comprises two or more parallel discs, welded together by their center with a shaft or axis and radially by an adequate number of paddles with their surfaces perpendicular to the planes of the discs. The paddles form spaces with a rectangular truncated pyramid shape, isolated from each other, but totally open on their wider base, which is the the circular part farthest from the center of the impulse wheel (10).

The container (11) (FIG. 1), for ease of description, is divided into three sections, (A), (B) and (C).

Section (A) shows half of the impulse wheel (10), installed by the concavity of the semicircular base of the container (11). At the top, the oil fill valve is located (13).

Section (B) shows the other half of the impulse wheel (10) and part of the container (11). Sections (A) and (B) together form a single enclosure filled with oil, which acts as a transmitter of forces, lubricant and coolant of the electric motor.

Section (C) shows an air chamber (or any other suitable gas) with a fill valve and a pressure gauge. Between section (B) and section (C) a flexible membrane (12) separates the oil chamber from the pressurized air.

Operation

FIG. 1—While the impulse wheel (10) is not moving, if we set the pressure of the air chamber section (C) to, e.g., two to three (2-3) atmospheres, the flexible membrane acts like a spring, pressing, regulating, and equilibrating in all directions with the same pressure and elasticity, oil around the container (11). Equally, the centripetal pressures that the impulse wheel (10) receives from all directions are equal. Since all pressure forces are equal and opposite, they are all neutralized and the container (11) does not move.

But if by means of an motor (electric or otherwise) we opted to rotate the impulse wheel (10) at certain speed, the oil moves quickly, and turbulences are formed. But the pressures that act on the internal walls of the container (11) continue to be equal in all directions, keeping the forces neutralized. However this does not occur with the impulse wheel (10), since the centripetal pressures on it coming from the oil in section (A) in the (Z) direction, have been reduced to a minimum. And the centripetal pressures on it in Section (B) are larger due to the turbulence and the pressure from the air chamber in Section (C). In consequence, the container moves in the (Y) direction.

Once a convenient fixed rotating motor speed has been established, we have the possibility of regulating the air chamber pressure in Section (C) until we get optimal efficiency.

The reason why container (11) can be moved from its interior by the impulse wheel (10) in the (Y) direction, is that when we rotate, the oil, which transports and pushes in Section (A) has a tendency to follow a tangential direction, but the curved wall of the container (11) does not allow it, resulting in a centrifugal push against such wall. The reaction to this push is not radially centripetal. As a consequence, this allows a high pressure and a low pressure region to coexist in the same inter-paddle chambers within the impulse wheel (10). These low pressure or depression is located in inter-paddle chambers near the center of the wheel. Following this line of reasoning, there is no net reaction impulse in Section (A) in the (Z) direction.

The forces are different in Section (B) since there is no curved wall, the depressions are nullified due to turbulences that are formed in the oil arising from the constant pressure maintained by the air chamber in Section (C), forming pressures on the impulse wheel (10) that pushes the container (11) at its axis in the (Y) direction.

Section (A) of FIG. 1—Within Section A, the rotating impulse wheel (10) does not receive in the (Z) direction the oil pressure that the air chamber section (C) transmitted. The oil that fills the impulse wheel, is forced to rotate at high speed but can not move centrifugally due to the curved wall of the container (11), exerts pressure on the surface of wall, while the wall exerts a matching centripetal counter force over the oil, and as a reaction the container (11) is pushed in the (Y) direction. Simultaneously, in the same section (A), an important near-vacuum or depression is created in the center of the hydraulic impulse wheel (10), causing it to add to the thrust in the (Y) direction by the greater pressure it receives from section (B).

Section (B) of FIG. 1—The turning the impulse wheel (10) forms centrifugal pressures in its internal chambers that are higher than the pressure of the air in the air chamber section (C). Therefore some of that oil exits the inner-wheel spaces tending to create depressions in its center, but due to the pressure and elasticity transmitted from the air chamber, oil is restituted in such spaces reducing these depressions. These centrifugal and centripetal currents may cause turbulence inside and outside of these spaces as they converge with each other and with other pressures from the bounce of the container (11) walls. The result is that in Section (B), there is a greater thrust in the (Y) direction.

Section (C) of FIG. 1—In this Section is located the air chamber with its regulated pressure. This pressure produces a push of the container (11) in the direction of (Z) and pushes the oil by means of the membrane (12) in the direction of (Y), constantly adjusting and equalizing pressure, transmitting its elasticity and contributing to greater push of the impulse wheel in the (Y) direction while maintaining their spaces filed with oil and reducing depressions.

Summing up all thrusts resulting in the (Y) direction of the container (11), they exceed the resulting thrust in the direction of (Z), so the container will be driven in the direction of (Y) when the impulse wheel is turning.

Additional Details

Given the complexity of multiple pressures with different directions and intensities, or the effects of viscosity of the fluids, or possible cavitations, vibration problems can arise which must be neutralized as much as possible by changing the rotation speed, the pressure on the fluid, or the shape of container and the impulse wheel.

The flexible membrane separates the pressurized air from oil and its fluctuations do not directly affect the container by pulling or pushing. All the pressures in the container are associated with the pressurized air, the oil pressure and the impulse wheel through its axle.

Since the flexible membrane separates a fluid with negligible compressibility (e.g., hydraulic oil) from a compressible gas-phase fluid (air), any movement of the flexible membrane generates very different results in the pressures of both fluids, with the gaseous fluid (air) being the one that varies its pressure the least, constantly acting as a regulator. The net effect is a near-constant pressure variable-volume air chamber, and a near-constant volume variable-pressure oil chamber.

Being a fixed amount of oil (constant volume), any movement of the flexible membrane compressing the air in the section (C) chamber, by the pushing liquid would create a vacuum in section (B), inside of the impulse wheel (10) chambers. But this vacuum is not formed because the greater pressure, from the air chamber prevents it keeping the membrane in its position. This should occur whenever the speed of the impulse wheel is suitable for the air pressure, which must be regulated to that speed.

Regulation and Performance Optimization Can Be Impacted by Changing:
1 The rotation speed of the paddle wheel
2 The pressure and volume of the air chamber
3 The amount of oil calculated so that the flexible membrane of the air chamber works in the most relaxed position when the space drive has maximum efficiency
4 The mechanical design of the impulse wheel, such as the number of paddles, their shape, the proximity to the curved wall of the container and the diameter of its axle.
5 The container design and alternatives
6 The flexible membrane design and mechanical properties such as elasticity, flexibility and strength.
7 The amount, quality, pressure and type of gas: air or other suitable gas
8 The characteristics and quantity of the liquid fluid: transmission or hydraulic oil, or any other fluid that minimizes frictional heat loses, a lubricant, and its viscosity to be optimized to be the most convenient for the application.
9 To prevent its tendency to turn, the vehicle will carry two or more impulse wheels to spin opposite to each other as to counterbalance their rotational motion, in one, two, or more containers.
10 To cool the oil: radiating fins refrigerating fins, or air, or if necessary immersed in water or any other liquid, with a radiator. The cooling fins will also have the function of giving greater strength and rigidity to the container to prevent volume changes due to internal or external pressures.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A Space Impulse Drive that can move with acceleration in vacuum without external support points and without need of expulsion of any matter outside to get a reaction, using a suitable source of energy.

2. The impulse Drive in claim 1 where the device consists of a container, prism-shaped quadrilateral with two irregular bases. A base is adapted to the curvature of the impulse wheel and the other as suitable, divided into two parts separated by a flexible membrane, where one part is constant-pressure filled with pressurized compressible gas and the other with constant-volume oil, with the air and oil pressures being equilibrated by means of a flexible membrane, with the oil submerging the impulse drive wheel witch spins the oil by means of a motor, causing a net impulse force by the imbalance of forces between the chambers.

3. The impulse Drive in claim 2 where two or more impulse drives are combined operating with opposite or counterbalancing directions of rotation preventing the tendency to turn the vehicle where it is installed.

4. The impulse drive of claim 3 as installed for the propulsion of any vehicle for operation in land, water, ice, snow, air, or vacuum.

5. The impulse drive of claim 3 as installed for the propulsion of a flying vehicle or device, without wings, propellers or rudders.

6. The impulse drive of claim 3 as installed for the propulsion of a spacecraft in vacuum, outer space or through a gas in any atmosphere.
